(19) United States
(12) Patent Application Publication
(10) Pub. No.: US 2012/0173679 A1
(43) Pub. Date: Jul. 5, 2012

(54) ADAPTATION METHOD, ADAPTER AND ADAPTER SYSTEM FOR NETWORK SERVICE COMMUNICATION

(76) Inventor: Sun Yue Li, Hong Kong (HK)

(21) Appl. No.: 13/318,479

(22) PCT Filed: Apr. 30, 2010
(86) PCT No.: PCT/CN2010/000598

§ 371 Date: Jan. 16, 2012

(30) Foreign Application Priority Data
May 4, 2009 (CN) 200910137108.4

(51) Int. Cl. G06F 15/173; G06F 15/177

(52) U.S. Cl. 709/220; 709/223

(57) ABSTRACT

A method for adaptation, an adapter and adapter system for the network service communication are provided in the present invention. Said method includes: transforming a network service request received from a first entity into a network service request comprehended by a second entity; sending the transformed network service request to the second entity; receiving a returned network service response responded by the second entity for said network service request; transforming the received network service response into a network service response comprehended by the first entity; returning the transformed network service response to the first entity. A client application system can send a network service request in its own format, a network service request corresponding to a third party system is not needed, and the repeated compiling of such network service code is avoided.

### TECHNICAL FIELD

The present invention generally relates to the field of network service communication, particularly to the network service communication between different entities.

### BACKGROUND

In the past, various software products developed for a variety of businesses are individually designed based on different concepts or functions, and such software products often cannot communicate with each other. The users (such as companies or enterprises), who need the applications related to various businesses, often need to purchase various software products; however, because such software products cannot communicate with each other, the users possessed of more than one such software product have to invest a lot of manpower and material resources in maintaining “information isolated islands”. Furthermore, with respect to such information, there may be data consistency and integrity problems, and a lot of redundancy may exist.

For this purpose, the service-oriented architecture (SOA) has been introduced and widely applied in recent years, which is considered one form of information system architecture and can create applications through combining the loosely coupled interoperable services independent of the platform and programming language.

Network service is the software system designed to support interoperable machine to interact with other machines through network (e.g. Internet). There are two popular network services on the market, one is based on the Simple Object Access Protocol (SOAP) and the other one is based on the Representational State Transfer (REST) approach. As long as a well-defined SOAP network service and the relevant components sharing data in XML format are achieved for each software, such as enterprise service bus (ESB), middleware and composite applications, there is a possibility to address the consistency between the existing software products.

The “dialogue” in XML format generally comprehended between software products is more efficient than the conventional API programming, but the network services of different software products (based on SOAP agreement or REST approach) are usually achieved in different ways based on software design. References to FIG. 1 are made to describe this situation. As shown in the figure, the client application system 101 is, for example, based on the REST approach, whereas the third party system 105 which will communicate with the client application system is, for example, based on the SOAP protocol. If the client application system 101 needs to communicate with the third party system 105, it is necessary to acquire the language (called web services description language (WSDL)) which describes the interface and is based on XML from the third party system 105, then the developers compile the web service request 110 comprehended by the third party system based on the acquired WSDL. This approach increases the programming burden for the client application system 101.

Moreover, in FIG. 1, the format of the network service response 112 returned from the third party system 105 to the client application system 101 is a format which can be comprehended by the third party system, and the client application system 101 generally cannot comprehend the network service response 112, so the client application system 101 cannot enjoy the network service provided by the third party system 105.

In addition, the client application system 101 and the third party system 105 are based on different protocols, even if the two systems are based on the same approach (for example, based on the REST approach, or based on the SOAP protocol), they still cannot communicate with each other as long as there is a discrepancy between their communication rules.

### SUMMARY

In view of the above situation, it is necessary to provide a method for adaptation for the network service communication between the client application system and the third party system, with this method, when one party sends the network service request or network service response in its own format, the other party can also comprehend it, so as to achieve effective communication.

According to one aspect of the present invention, a method for adaptation for the network service communication between a first entity and a second entity is provided, including: transforming the network service request received from a first entity into the network service request comprehended by a second entity; sending the transformed network service request to the second entity; receiving the returned network service response responded by the second entity for said network service request; transforming the received network service response into the network service response comprehended by the first entity; returning the transformed network service response to the first entity.

According to another aspect of the present invention, an adapter for the network service communication between a first entity and a second entity is provided, including: a request conversion device, which transforms the network service request received from a first entity into the network service request comprehended by a second entity; and a transceiver, which sends the transformed network service request to the second entity, and receives the returned network service response responded by the second entity for said network service request; a response conversion device, which transforms the received network service response into the network service response comprehended by the first entity; and said transceiver is also used to return the transformed network service response to the first entity.

According to yet another aspect of the present invention, an adapter system for the network service communication between a first entity and a second entity is provided, including: one or more adapters according to the present invention; and a redirection device, which allocates the network service request to the corresponding one or more said adapters based on the service requested by the network service request from the first entity.

Through using the adapting method based on the embodiments of the present invention, a client application system can send a network service request in its own format. With this adapting method, the network service request sent by the client application system is transformed into the network service request comprehended by the third party system, thus avoiding the trouble for the client application system to compile the network service request codes corresponding to the format requirements of different third party systems. Moreover, with this adapting method, the network service response returned by the third party system is transformed into the network service response comprehended by the client application system, so that the client application system can comprehend the network service response returned by the third party system, thus accepting the network service provided by the third party system and achieving effective communication. Furthermore, with this adapting method, the two parties can also achieve communication with each other when the third party system sends the network service request to the data application object in the format comprehended by itself and the data application object returns the network service response in the format comprehended by itself. In this way, the transformation from one REST approach to another REST approach, from the REST approach to the SOAP protocol, from the SOAP protocol to the REST approach and from one SOAP protocol to another SOAP protocol can be achieved. In addition, the present invention is not limited to the conversions illustrated above, but is applicable to all conversions between communication protocols or communication approaches being developed at present or to be developed in the future.

Also, the adapter based on the embodiments of the present invention can avoid the trouble for the client application system to compile the network service request codes corresponding to the format requirements of different third party systems, and make the client application system accept the network service provided by the third party system, thus achieving effective communication. Furthermore, with this adapter, the two parties can also achieve communication with each other when the third party system sends the network service request to the data application object in the format comprehended by itself and the data application object returns the network service response in the format comprehended by itself In this way, the third party can communicate with the client application system and/or data application object. Under the circumstance that the user has been possessed of some business systems, these existing business systems can be integrated with the network application system of the invention through the network service adapter, so as to save resources for the user's company and avoid the waste resulting from repeated investment.

Furthermore, the adapter system based on the embodiments of the present invention provides a unified interface for different client application systems to access various different third party systems, so that different client application systems can enjoy the network service provided by various different third party systems through sending the network service requests of unified format to the unified address of the adapter system, without the need to take into consideration the specific operations of each adapter and various third party systems.

### BRIEF DESCRIPTION OF THE DRAWINGS

FIG. 1 is the schematic diagram of the interaction between the client application system and the third party system based on the prior art;

FIG. 2 is the schematic diagram that the client application system interacts with the third party system through using the adapter based on the embodiment the present invention;

FIG. 3 is the general flow diagram according to the embodiments of the present invention;

FIG. 4 is the flow diagram of the network service request conversion according to the embodiments of the present invention;

FIG. 5a is the block diagram of the application object according to the embodiments of the present invention;

FIG. 5b shows how the plane structure data application objects are linked with each other according to the embodiments of the present invention;

FIG. 6 is the flow diagram of the conversion process according to the embodiments of the present invention;

FIG. 7 is the block diagram of the adapter according to the embodiments of the present invention;

FIG. 8 is the schematic diagram of the adapter system according to the embodiments of the present invention; and

FIG. 9 schematically shows the block diagram of the computing devices, which can be used to realize the embodiments of the present invention.

### DETAILED DESCRIPTION

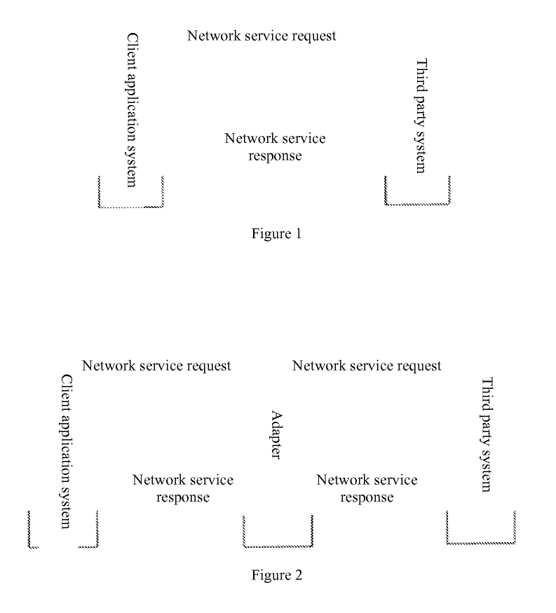

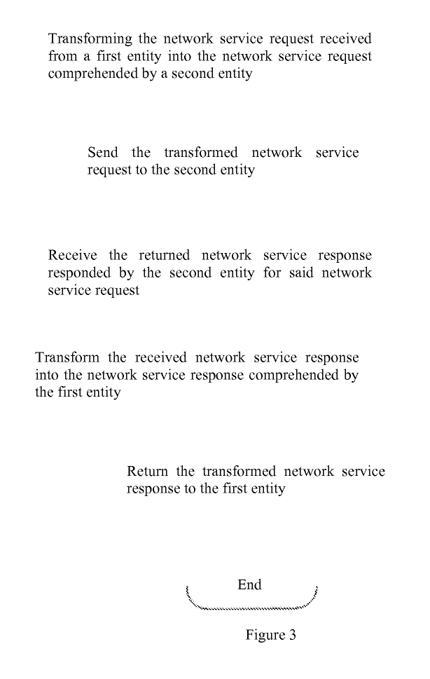

References to FIG. 3 are made to describe the present invention in combination with FIG. 2. Wherein, FIG. 2 shows the schematic diagram that the client application system interacts with the third party system through using the adapter based on the embodiment the present invention, and FIG. 3 shows the general flow diagram according to the embodiments of the present invention.

Referring to FIG. 3, in step 301, the network service request received from the first entity is transformed into the network service request comprehended by the second entity.

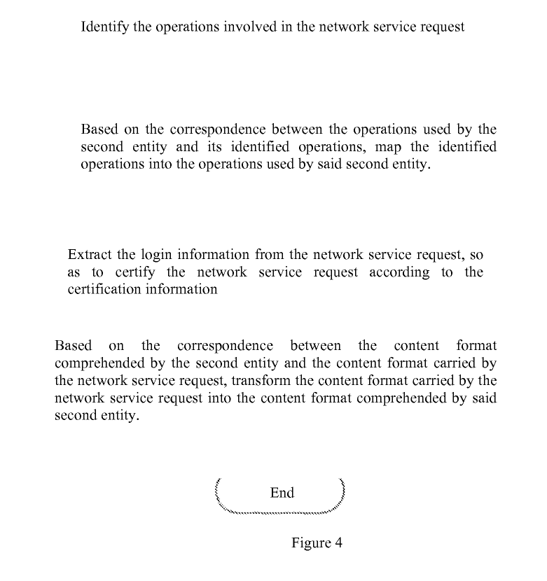

Specifically, in FIG. 2, the adapter 203 will transform the network service request 210 received from the first entity, for example, the client application system 201, into the network service request 210′ comprehended by the second entity, for example, the third party system 205, wherein, the network service request 210 can be based on the Simple Object Access Protocol (SOAP) or the Representational State Transfer (REST) approach. With respect to the specific steps for network service request conversion, detailed description is made by references to FIG. 4.

The adapter 203 can run on a support system, and can be developed based on the technologies which achieve the support system, such as .Net, JAVA, PHP, C, C++, Ruby and Python. The support system refers to the combination of the following features: any platform allowing the adapter to run on it, e.g. the operating system; any database management system allowing the information and data related to the adapter to reside on it, e.g. RDBMS, Oracle, DB2, MySQL, MS SQL; an application framework allowing the adapter developed by using various programming languages (e.g. JavaScript, VBScript, .NET, Java, PHP, C, C++, Ruby, Python) to run on it; and the equipment or systems allowing the operation of any platform, database management system and application framework.

The client application system 201 can be any network client application which can control the content and layout directly or indirectly running on any operating system. The network client application 201 can be a rich internet application (RIA) run by using or not using a network browser, such as Flash application, Java application, JavaFX application, Adobe Flex/AIR application, Microsoft Silverlight application, wherein the RIA can run on a dedicated network browser plug-in, or run independently through Sandbox guaranteeing safe operation of programs; or, it can be a script application running on a network browser, such as Javascript application, VBScript; or other applications developed with various programming languages (such as .NET, Java, C, C++, Ruby and Python) and directly running on the operating system. Moreover, the network client application can be any network-based application, and based on Windows operating system, Linux system, or any other appropriate operating system. The client application system 201 can even be linked to the small applications of any appropriate website (e.g. company website, Blog and large commercial websites, like Alibaba and Eachnet) for convenient use. For example, a user can link its product catalogue and online inquiry & payment to the websites of its cooperators for convenient use.

The third party system 205, for example, can be the system of other parties (e.g. the company's clients, suppliers, cooperators) which constitute a consortium with the user of the client application system 201, or the system of other departments of the company. The third party system 205 is generally an application system different from the client application system 201; therefore, its network service request and response are possibly different from that adopted by the client application system 201.

With respect to the detailed description about the adapter 203 of the present invention, please refer to the subsequent part of the Detailed Description of the Preferred Embodiments.

Moreover, the client application system 201 can run on any equipment or system, as long as the equipment or system can achieve the communication with the second entity, for example, the third party system. The equipment or system can be personal computers, e.g. desktop computers; handheld computing devices, e.g. iPhone, Blackberry, the mobile phones with Windows Mobile system installed and smart phones; portable computing devices, e.g. notebooks, netbooks; and workstations, computing device network, etc.

In step 303, the transformed network service request is sent to the second entity.

Specifically, in FIG. 2, depending on the protocol on which the third party system 205 is based, e.g. SOAP protocol or REST approach, the adapter 203 can make the transformed network service request into the network service request 210′ with its format conforming to the SOAP protocol or REST approach, and then sends it to the third party system 205. To make the network service request with its format conforming to the SOAP protocol or REST approach includes, for example, filling the transformed network service request in the corresponding field of the network service request with conforming format, and replacing the address of the adapter 203 in the network service request with the address of the third party system which provides the network service. These belong to the prior art and are not the key to the present invention.

In step 305, the returned network service response responded by the second entity for said network service request is received.

Specifically, in FIG. 2, the adapter 203 receives the returned network service response 212 responded by the third party system 205 for said network service request 210.

In step 307, the received network service response is transformed into the network service response comprehended by the first entity.

Specifically, in FIG. 2, the adapter 203 transforms the network service response 212 into the network service response 212′ comprehended by the first entity. This step is similar to the optional conversion step for the network service request conversion, so please refer to the conversion step described in detail below.

In step 309, the transformed network service response is returned to the first entity. Specifically, in FIG. 2, the adapter 203 returns the transformed network service response 212′ to the client application system 201.

In combination with FIG. 2, references to FIG. 4 are made to describe the conversion process of the network service request through specific examples. Referring to FIG. 4, step 401 identifies the operations involved in the network service request.

As known to those skilled in the art, HTTP method is a limited set of methods, including GET, PUT, POST, DELETE, HEAD, OPTIONS, TRACE and CONNECT. Among these methods, only GET, PUT, DELETE and POST involve the operation of the resources on the server. The network service based on the REST approach uses said four operations, whereas the network service based on the SOAP protocol only uses POST.

Specifically, in FIG. 2, assume that the network service request 210 sent to the adapter 203 by the client application system 201 based on REST approach is a HTTP network service request, which includes a header, and the header includes a request line: GET HTTP://myhost.com/contacts HTTP 1.1, wherein, GET is the HTTP method field, HTTP://myhost.com/contacts is the Unified Resource Identifier (URI) (wherein myhost.com is the address of the adapter 203, HTTP 1.1 is the version of the HTTP protocol); and optionally includes other information, e.g. login information.

The adapter 203 identifies the network service request 210 as a GET request based on the HTTP method field in the request line, and it wants to get the list of contact records from the adapter 203 (in fact, the adapter 203 will get the list from the third party system 205).

In step 403, based on the correspondence between the operations used by the second entity and its identified operations, map the identified operations into the operations used by said second entity.

Specifically, in FIG. 2, based on the correspondence between the operations used by the third party system and the operations identified from the network service request 210, the adapter 203 maps the operations identified from the network service request 210 into the operations used by the third party system 205.

For example, assume the third party system 205 is based on the SOAP protocol and has member resources and the following operations:
makeMember: used to create a member;
changeMemberinformation: used to update the member information;
removeMember: used to remove a member;
getMember: used to get a member;
getMemberList: used to get the member list.

Based on the correspondence between the network service request 210 for getting the list of contact records and the getMemberList used for this purpose in the third party system 205, the adapter 203 maps the GET operation in the network service request 210 into the getMemberList operation used in the third party system 205.

Wherein, the correspondence between operations can be configured in advance through using the configurator of the present invention by the adapter administrator who understands the operation of the third party system, and can be stored in any memory device which can be accessed by the adapter, such as database, flash memory, hard disk, floppy disk, CD and DVD, so that the adapter can read and access it when necessary; or, the name and function of the operation can be obtained from the third party system at any time prior to the mapping operation, and the correspondence can be established based on the function and name. Moreover, the adapter administrator or the third party system can use the adapter to update the name and function of the operations used by the third party system at any time.

Wherein, the configurator of the present invention can be a tool to configure the adapter and is used in the adapter to configure the correspondence between the operations used by the two communication parties. It can be packaged, published and run together with the adapter, or be located, as a separate tool, on any equipment which can communicate and connect with the adapter. In one embodiment of the present invention, the configurator can be a graphical user tool, so as to facilitate the administrator to configure the adapter. The adapter can display the operations of the client application system and the operations of the third party system simultaneously. The adapter administrator can choose one of the operations of the client application system through simply “clicking”, and then “link” or “drag” it to another operation of the third party system, so as to define the correspondence between the two operations, and achieve the information configuration which will be used when the adapter transforms the network service request. In another optional embodiment, the configurator can also be a simple text editor used to edit the configuration file, so as to describe the correspondence between the operations used by the two communication parties. It should be understood that the configurator can be any tool which can edit configuration information.

However, it is noted that said way to configure the correspondence between operations is only an example used to illustrate the purpose, and the present invention is not limited to this. Such correspondences can also be configured through code compilation by the developer in the process of application development, or configured in any other appropriate way which can achieve the correspondence configuration.

Moreover, it is noted that the configurator in the form of graphical user tool and the configurator in the form of text editor descried above are also examples used to illustrate the purpose, and the present invention is not limited to this. The configurator can be any device which can configure such correspondences.

In step 405, extract the login information from the network service request, so as to certify the network service request according to the certification information.

Specifically, in FIG. 2, the adapter 203 extracts the login information (e.g. user name and password) from the network service request 210, and matches it against the certification information. In the case of marching, the client application system 201 is allowed to access the network service provided by the third party system 205 through the adapter 203; in the case of mismatching, the client application system 201 is not allowed to access the network service provided by the third party system 205 through the adapter 203

Wherein, the certification information can be configured in advance through using the configurator of the present invention by the adapter administrator who understands the provisions on the login authority of the third party system, and can be stored in any memory device which can be accessed by the adapter, such as database, flash memory, hard disk, floppy disk, CD and DVD, so that the adapter can read and access it when necessary; or, the certification information can be obtained from the third party system at any time prior to the certification. Moreover, the adapter administrator or the third party system can update the provisions on the login authority of the third party system at any time.

Wherein, the configurator of the invention is used to configure the certification information specific to other systems which will access the third party system.

It is noted that in the case of not considering the security, the third party system 205 does not necessarily certify the login information of the client application system, that is, the step 405 is an optional step.

As the HTTP network service request 210 for getting the list of contact records does not include an entity, the transformation of the network service request 210 (GET) has been completed so far. Similarly, through said steps, the transformation of other HTTP network service requests can be completed, and these network service requests include: the HTTP network service request (GET) for getting a contact record and the HTTP network service request (DELETE) for deleting resources.

Furthermore, for the HTTP network service request ‘PUT’ (used to store the data in an entity onto the server or modify the existing resources on the server) and POST (the user uses the data in an entity to create new resources) which include an entity, the step 407 must be carried out. In step 407, based on the correspondence between the content format comprehended by the second entity and the content format carried by the network service request, the content format carried by the network service request is transformed into the content format comprehended by said second entity.

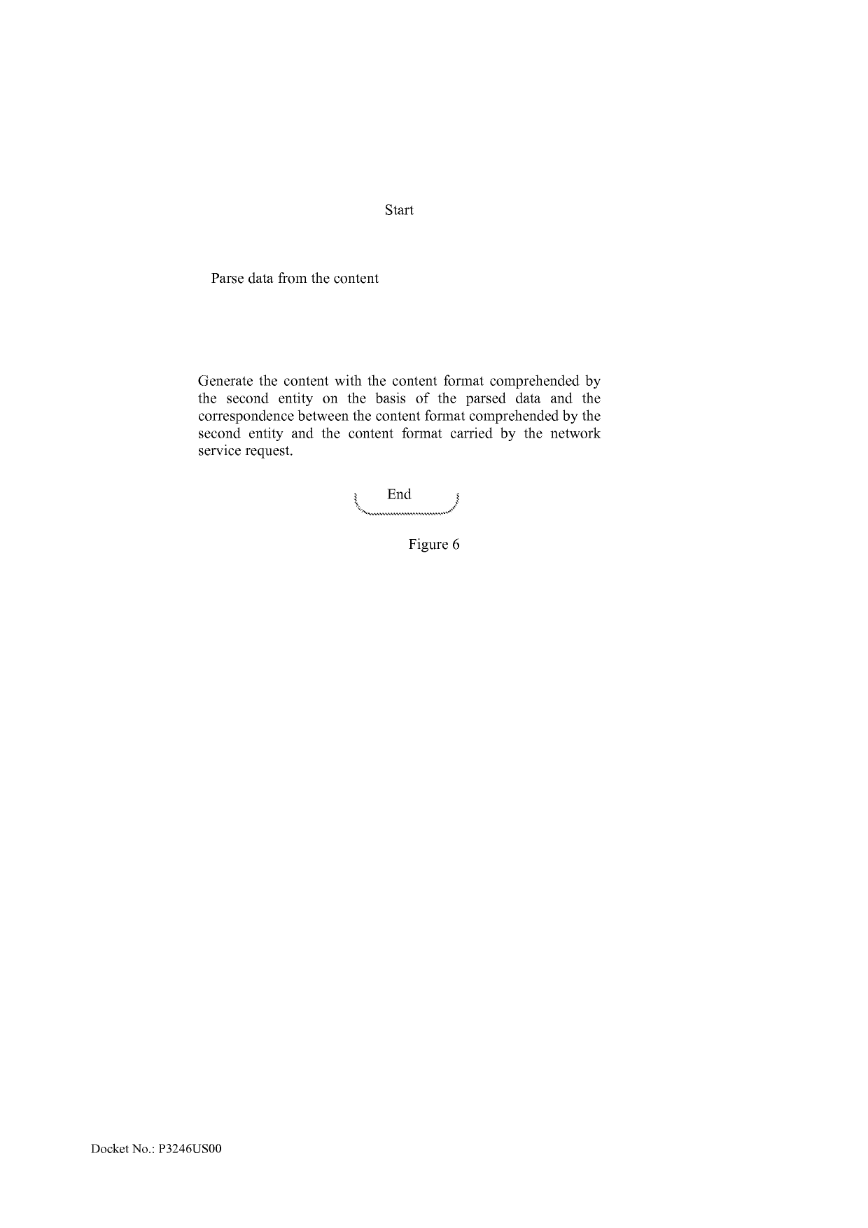

The step 407 of content format transformation is described through examples and by references to FIG. 6. In the following examples, the description is made by references to the application environment of an application object based on the plane structure storage method.

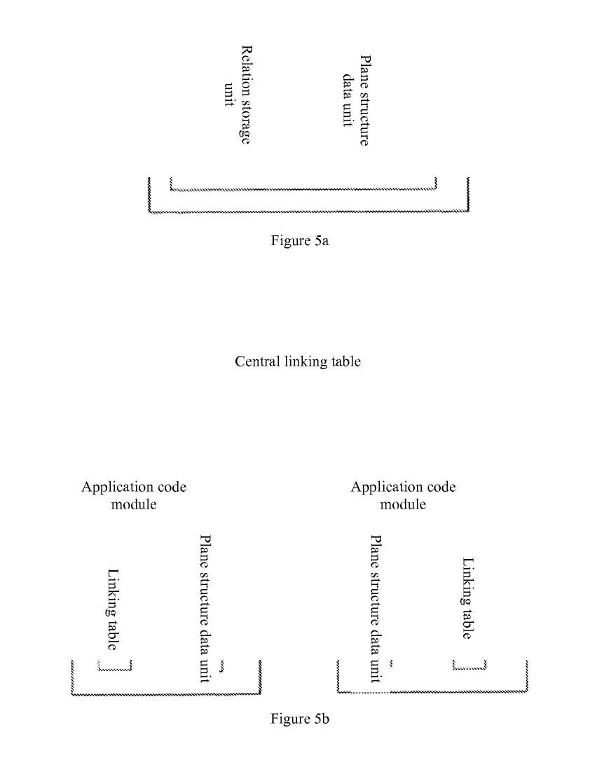

Firstly, references to FIG. 5a and FIG. 5b are made to briefly describe the application object. FIG. 5a and FIG. 5b are the block diagram of the application object based on the plane structure storage method and the diagram of the way in which the application objects are linked according to the embodiments of the present invention respectively.

As shown in FIG. 5a, the application object 500 includes the plane structure data unit 501 dedicated to storing data of a special type, such as contact information, order information, project information or application-related configuration information. When the application object stores common business data, it plays a role in providing data service for the client application system, thus it can also be called “data application object”; however, when it is used to configuration information of the client application system, it can also be called “platform”.

The application object 500 also includes a relation storage unit 502 for storing the relations between the data in the plane structure data unit of each application object; and an application code module 503 for operating the information in the plane structure data unit and the relation storage unit in response to the network service request.

As shown in FIG. 5a, the application object 500 runs on the support system 590, and the support system 590 refers to the combination of the following features: any platform allowing the application object 500 to run on it, e.g. the operating system; any database management system allowing the plane structure data unit 501 and the relation storage unit 502 to reside on it, e.g. RDBMS, Oracle, DB2, MySQL, MS SQL; an application framework allowing the application code modules 503 developed by using various programming languages (e.g. JavaScript, VBScript, .NET, Java, PHP, C, C++, Ruby, Python) to run on it; and the equipment or systems allowing the operation of any platform, database management system and application framework.

In FIG. 5b, the data application objects 510 and 520 are shown, wherein the data application object 510 includes the plane structure data unit 511, linking table 512 and application code module 513, and the data application object 520 includes the plane structure data unit 521, linking table 522 and application code module 523; the central linking table 530 is also shown, which can be stored, for example, on a “platform”.

Wherein, the plane structure data units 511 and 512 are used to store the information of a special type, and can be a simple XML document or a single logical table in a relation database, such as MySQL, MS SQL, Oracle and DB2 (although the plane structure data unit can be achieved through the tables stored in different locations). According to the invention, the plane structure data units 511 and 512 of each application object is dedicated to storing the data of a special type, that is, different types of data are stored in the plane structure data units of different application objects, and the types of the data stored in the plane structure data units of different application objects are different from each other. However, different from the traditional relation databases, the relations between the data stored in the plane structure data unit and the data stored in the plane structure data units of other application objects are not expressed through adding a foreign key into a table, for example, but through the linking table included in the plane structure data application object. In this way, one plane structure data unit can only store the information of the same type, whereas the links between different types of information can be separately stored in the linking table. For example, the plane structure data unit 511 is used to store the account information, whereas the plane structure data unit 521 is used to store the contact information.

The application code modules 513 and 523 are used to receive the network service request from the client application system for operating the information in the plane structure data units 511 and 521 and the linking tables 512 and 522 respectively, and perform the basic operations (such as creation, getting, renewal and deletion) according to these network service requests.

The linking tables 512 and 522 are used to store the linking information between the data in the plane structure data units of the plane structure data application objects 510 and 520 respectively and the linking information between the data in the plane structure data units of other such data application objects.

Preferably, the central linking table 530 also stores the linking information corresponding to said linking tables 512 and 522 for functional purpose or maintenance purpose, for example, it can be used to restore the lost linking information when the linking information in the linking table 512 or 522 is lost.

For example, if the first record Joe Ma stored in the plane structure data unit 521 is subordinate to the first record company A stored in the plane structure data unit 511, that is, a linking relation exists between them, thus there is a record indicating the linking relation between them in the linking table 512, and the record includes the identification of the record company A, the identification of the data application object 520 and the identification of the record Joe Ma. Similarly, there is also a record indicating the linking relation between them in the linking table 522, but the record includes the identification of the record Joe Ma, the identification of the data application object 510 and the identification of the record company A. Optionally, the central linking table 530 includes the identification of the data application object 510, the identification of the record company A, the identification of the data application object 520 and the identification of the record Joe Ma.

It is noted that the linking table is just an example of the relation storage unit used to store the relations between the data stored in each plane structure data unit. The invention is not limited by this, and any other appropriate technology can be adopted to store these linking records, such as XML file and other files, as long as such linking information can be maintained. Other relevant technical details on achieving the storage of linking records are known to those skilled in the art.

The use of the plane structure data application object can ensure the good extensibility of the database, and the user can create a single logical table for any type of information; when it is needed to link the two records, the linking relation between the two records can be established through storing such two records in the two linking tables corresponding to the two plane structure data units respectively, and preferably, adding said linking records into the central linking table, so as to link the two records; and when there is no connection between the two records, the linking relation can be removed through simply deleting the records in the linking tables.

If both the plane structure data unit and the relation storage unit are XML file, each such file only store the data of one special type or store the linking relations between different types of information which has linking relations; therefore, this type of XML file can be called the single-level XML structure of plane structure format. The advantages that each type of information is stored in a separate XML structure are similar to the advantages that a single logical table structure is used in the database, for example, a separate XML structure has good extensibility, the information stored in the XML structure is loosely coupled, and the linking relations between information can be established or removed through simply adding or deleting the records in the XML structure indicating linking relations.

For the details about the plane structure data application object, please refer to the patent application (applicant: TAM, Ka Fai, Keith; application number: “”; invention title: “Service-oriented application system and communicating method, creator and creating method thereof”) submitted on the same day when this application is submitted.

When operating the data in such data application objects through using the HTTP network service request based on REST approach or SOAP protocol, the client application system preferably uses said single-level XML structure of plane structure format. If the data application object uses the single-level XML structure of plane structure format, it is more suitable to use the single-level XML structure of plane structure format.

Under this application environment, for the purpose of convenience, the client application system, in general, will uniformly use such XML structure to request network service from the data application object and the third party system. As the third party system will not necessarily use such XML structure, through using the adapter of the present invention, the

HTTP network service request sent or the HTTP network service response returned by the third party system can be transformed into the single-level XML structure of plane structure format comprehended by the client application system or the plane structure data application object of such XML structure, so as to adapt for the network service communication between them.

It is noted that according to the present invention, the first entity can be the client application system or the data application object, or can be the third party system; accordingly, the second entity can be the third party system or can be the client application system or the data application object.

The adapter of the present invention can be a separate entity located on the server side, or can be integrated with the client application system, the third party system or the data application object.

In the above, reference to FIGS. 5a and 5b has been made to describe the application environment of the application object based on the plane structure storage method. By taking the application environment described above as an example, the step 407 of content format transformation is further described in detail. As known to those skilled in the art, the entity of the HTTP network service request can carry the data of any format; however, in the following, only the carried content of XML structure (hereinafter XML content) is taken as an example, so as to describe how to transform the content of the network service request.

### Example 1

For example, the XML content of single-level XML structure which is carried by the network service request 210 and conforms to the plane structure format is as follows:

<age> 39 </age>
</our_flat_structure_record>.

Wherein our_flat_structure_record is the label indicating one record, and its designation is only for the illustrative purpose rather than the restrictive purpose. The client application system of single-level XML structure using this plane structure format can randomly define the labels used by it. Preferably, all adapters use the same labels, so as to provide a unified convenient interface for the client application system.

Wherein, the labels “name” and “age” indicate the name and age of the contact respectively.

The content format comprehended by the third party system 205 is:

[symbol]

</Member>. [symbol]
indicates data missing or illegible when filed

Wherein, the labels “Member”, “FullName” and “Age” used by the third party system 205 indicate the member and the name and age of the contact respectively. It is noted that the designation of these labels is only for the illustrative purpose rather than the restrictive purpose; on the contrary, the third party system can use any label defined by itself.

In step 601, parse data from the content. Specifically, the adapter 203 parses the data of plane structure format from the XML content carried by the network service request 210.

name, Johnny Tong

age: 39,

In step 603, generate the content with the content format comprehended by the second entity on the basis of the parsed data and the correspondence between the content format comprehended by the second entity and the content format carried by the network service request.

Specifically, based on the respective correspondences between the labels “name”, “age” in the network service request 210 and the labels “FullName”, “Age” comprehended by the third party system, the adapter 203 learns that “Johnny Tong” in the network service request 210 should be filled in the “(a)” field of the content format of the third party system 205, and “39” filled in the “(b)” field; next, the XML content comprehended by the third party system 205 is generated based on the correspondence and data:

z,999

</Member>.

Similar to the configuration of the correspondence between operations described above, the correspondence between the content format used by the client application system and the content format comprehended by the third party system can be configured in advance through using the configurator of the present invention by the adapter administrator who understands the content format of the third party system, and can be stored in any memory device which can be accessed by the adapter, such as database, flash memory, hard disk, floppy disk, CD and DVD, so that the adapter can read and access it when necessary; or, the content format comprehended by the third party system can be obtained from the third party system at any time prior to the content transformation, and the correspondence between the content format comprehended by the third party system and the content format used by the client application system can be established. Moreover, the adapter administrator or the third party system can update the content format comprehended by the third party system at any time.

Wherein, the configurator of the present invention is used in the adapter to configure the correspondence between the content formats used by the two communication parties in the adapter. It can be packaged, published and run together with the adapter, or be located, as a separate tool, on any equipment which can communicate and connect with the adapter. In one embodiment of the present invention, the configurator can be a graphical user tool, so as to facilitate the administrator to configure the adapter. The adapter can display the content format used by the client application system and the content format used by the third party system simultaneously. The adapter administrator can choose one of the content formats of the client application system through simply “clicking”, and then “link” or “drag” it to another content format of the third party system, so as to define the correspondence between the content formats, and achieve the information configuration which will be used when the adapter transforms the content. In another optional embodiment, the configurator can also be a simple text editor used to edit the configuration file, so as to describe the correspondence between the content formats used by the two communication parties. It should be understood that the configurator can be any tool which can edit configuration information.

However, it is noted that said way to configure the correspondence between content formats is only an example used to illustrate the purpose, and the present invention is not limited to this. Such correspondences can also be configured through code compilation by the developer in the process of application development, or configured in any other appropriate way which can achieve the correspondence configuration.

Moreover, it is noted that the configurator in the form of graphical user tool and the configurator in the form of text editor descried above are also examples used to illustrate the purpose, and the present invention is not limited to this. The configurator can be any device which can configure such correspondences.

It can be understood that if the client application system 201 in the Example 1 uses the content format of the third party system 205, whereas the third party system 205 uses the single-level XML structure of plane structure format, the above transformation still can be achieved, and the way to achieve the above transformation is to reverse the source format and the target format.

### Example 2

For example, below are the three paragraphs of XML content of single-level XML structure which is carried by the network service request 210 and conforms to the plane structure format:

[symbol]

</our_flat_structure_records> [symbol]
indicates data missing or illegible when filed

[symbol]

</our_flat_structure_records> [symbol]
indicates data missing or illegible when filed

</our_flat_structure_link>
</our_flat_structure_links>

Wherein, the first paragraph of XML content stores the Account information; the second paragraph of XML content stores the Contact information; the third paragraph of XML content stores the information of the linking relations between Account and Contact.

It is noted that the labels our_flat_structure_records, our_flat_structure_links, our_flat_structure_link, FirstID, First_flat_structure_type, Second ID, second_flat_structure_type, CompanyName, Name and Phone respectively indicate the data record set, linking relation set, one linking relation, identification of one type of data involved in the linking relations, type of one type of data involved in the linking relations, identification of another type of data involved in the linking relations, type of another type of data involved in the linking relations, company name, contact name and phone respectively, and these labels are only for the illustrative purpose rather than the restrictive purpose. The client application system of single-level XML structure using this plane structure format can randomly define the labels used by it. Preferably, all adapters use the same labels, so as to provide a unified convenient interface for the client application system.

The format comprehended by the third party system 205 is:

</Account>
</Accounts>

Wherein the labels Accounts, Account, CompName, Contacts, Contact, Name and Phone comprehended by the third party system 205 indicate the account set, one account, company name, contact sets, one contact, contact name and phone respectively.

With respect to the example, in step 601, to parse the data from the content includes: parsing the data based on the information which is carried by said content and describes the link relations between data.

Specifically, parse data based on the third paragraph of the XML content indicating the linking relations between account and contact. The parsed data of plane structure format is:

Company Name: Company B
   |-Name: Mary To
   |-Phone: 31234567

Specifically, in step 603, the adapter 203 generates the XML content comprehended by the third party system 205 on the basis of the parsed data and the respective correspondences between the labels CompanyName, Name, Phone in the network service request 210 and the labels CompName, Name, Phone comprehended by the third party system 205:

</Account>
</Accounts>

### Example 3

For example, the XML content of single-level XML structure which is carried by the network service request 210 and conforms to the plane structure format is as follows:

[symbol]

</Accounts> [symbol]
indicates data missing or illegible when filed

With respect to the example, in step 601, to parse the data from the content includes: identification of the data hierarchy. Moreover, in step 603, to generate the content with the content format comprehended by the second entity includes: on the basis of the parsed data, the correspondence between the content format comprehended by the second entity and the content format carried by the network service request and the data hierarchy, creating the content (whose content format can be comprehended by the first entity and which includes data) for the data of each level, and creating the content (whose content format can be comprehended by the first entity and which includes linking relations) for the hierarchy of the data of different levels.

Specifically, identify the key labels in the network service request 210, that is, the labels which can indicate the data hierarchy. In this example, these key lables include: Accounts indicating a group of accounts, Account indicating one account record, Contacts indicating a group of contacts and Contact indicating one contact record.

Based on the identification result, the hierarchy of the key labels is learned, that is, Accounts includes Account, Account includes Contacts, and Contacts includes Contact.

Based on the hierarchy of the key labels, the data of tree structure is identified:

| | | |

[symbol]
| | | | [symbol] Phone : 31234567 [symbol]
indicates data missing or illegible when filed

Next, read the data of tree structure in the following order:
1. Find Accounts;
2. In Accounts, find the location of Account;
3. Create the single-level XML structure of plane structure format for each Account, which possesses the identification and CompName.
4. In Account, find Contacts;
5. In Contacts, find the location of Contact;
6. Create the single-level XML structure of plane structure format for each Contact, which possesses the identification, Name and Phone.
7. Create the single-level XML structure of plane structure format for the linking relations between Contact and Account.

Based on the above process, the three paragraphs of XML content of single-level XML structure conforming to the plane structure format are obtained as follows:

<Name> Joe Ma </Name>
<Phone> 91234567 <Phone>

- - -
</our_flat_structure_links>

Wherein, the first paragraph of XML content stores the Account information; the second paragraph of XML content stores the Contact information; the third paragraph of XML content stores the information of the linking relations between Account and Contact.

Next, the third party system 205 can store the information stored in the first paragraph of XML content and the information stored in the second paragraph of XML content into the data application object regarding the accounts and the data application object regarding the contacts. For example, if the plane structure data unit adopts the single logical table structure in the database, the information in the XML content can be parsed; if a single logical table specific to such information already exists in the database, the parsed information are written into the single logical table; if a single logical table specific to such information does not exist in the database, a single logical table will be created for it, and the parsed information will be written into the single logical table. If the data application object adopts the single-level XML structure of plane structure format, under the circumstance that there already exists the XML structure specific to such information, data will be parsed from the XML content, and the parsed data will be written into the XML structure; otherwise, the XML content will be used as the data unit in the data application object directly.

Furthermore, the third party system 205, based on the linking information stored in the third paragraph of the XML content, stores the corresponding linking relations into the linking table of the data application object regarding the accounts and the linking table of the data application object regarding the contacts.

Optionally, the third party system 205 can store the corresponding linking relations into the central linking table, and use the central linking table to fill each linking relation in the linking table of each related data application object.

Several cases of content transformation have been described only through taking XML as an example; however, those skilled in the art should understand that the above transformation can be conducted for the files of any well-defined and unambiguous format (which can be extracted as a list record or a single record), that is, comma-separated values (CSV) files. This can be achieved through using more parsers.

Moreover, through using said principle of transformation between files, the transformation from multi-level XML structure into multi-level XML structure can be easily achieved. For example, parse the data from one multi-level XML structure, and generate another XML structure based on the parsed data and the mapping relations between the used labels.

It is noted that as the network service response generally includes the content, the corresponding transformation of network service in step 307 of FIG. 3, that is, transformation of the network service response received from the second entity into the network service response comprehended by the first entity, also involves the transformation of the content format. Therefore, similar content format transformations can be achieved by reference to the above description and in combination with the illustrative process of Examples 1-3.

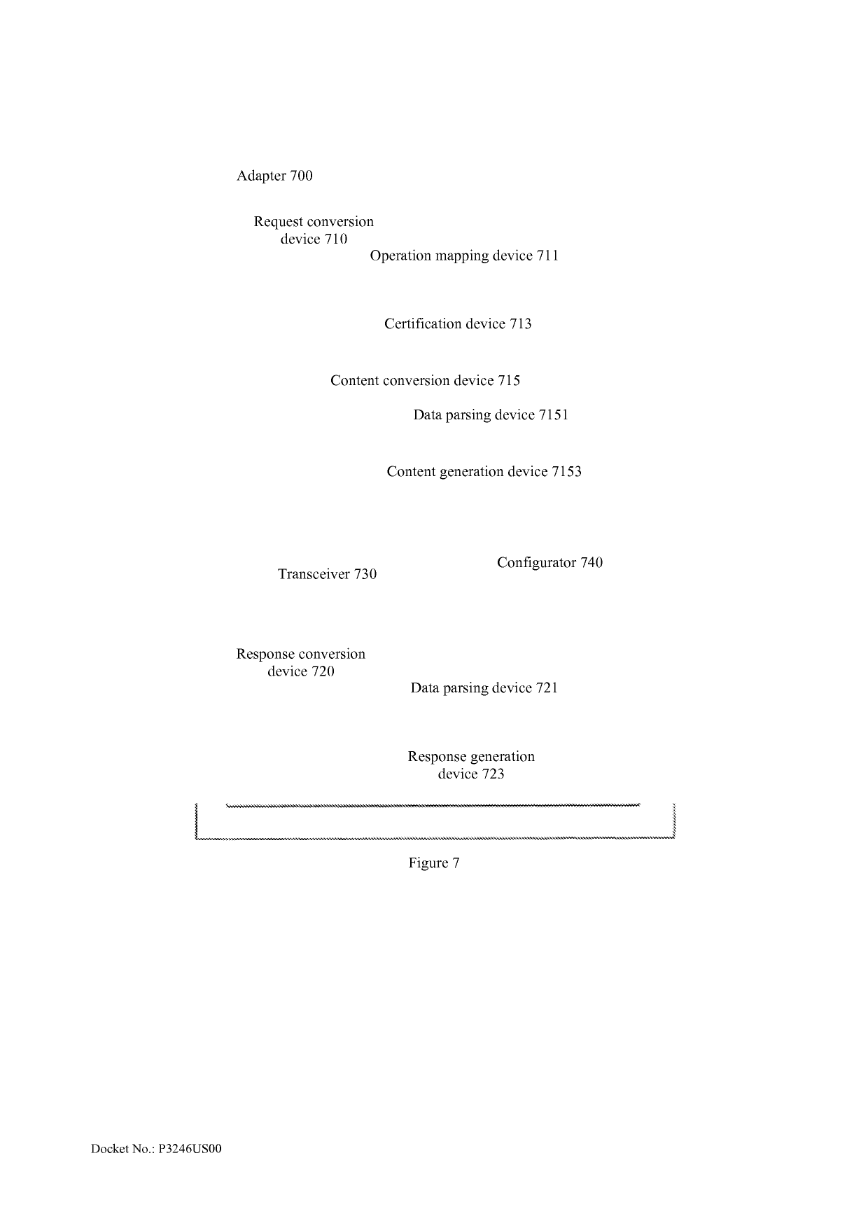

References to FIG. 7 are made to describe the structure of the adapter of the present invention. In FIG. 7, the adapter 700 includes a request conversion device 710, which transforms the network service request received from a first entity into the network service request comprehended by a second entity; a transceiver 730, which sends the transformed network service request to the second entity, and receives the returned network service response responded by the second entity for said network service request; a response conversion device 720, which transforms the received network service response into the network service response comprehended by the first entity; wherein the transceiver 730 is also used to return the transformed network service response to the first entity.

Optionally, the adapter 700 can also include a configurator 740, which is used to: configure the correspondence between the operations used by the second entity and the operations used by the first entity; configure the correspondence between the response format comprehended by the first entity and the response format comprehended by the second entity; configure the correspondence between the content format comprehended by the second entity and the response format comprehended by the first entity.

Wherein, the correspondence between the response format comprehended by the first entity and the response format comprehended by the second entity and the correspondence between the content format comprehended by the second entity and the response format comprehended by the first entity are the same correspondence, because only the source party and the target party are interchanged.

The request conversion device 710 can further include an operation mapping device 711, which is used to identify the operations involved in the network service request; map the identified operations into the operations used by said second entity on the basis of the correspondence between the operations used by the second entity and its identified operations.

Optionally, the request conversion device 710 can also include a content conversion device 715, which is used to transform the content format carried by the network service request into the content format comprehended by said second entity on the basis of the correspondence between the content format comprehended by the second entity and the content format carried by the network service request; a certification device 713, which is used to extract the login information from the network service request, so as to certify the network service request according to the certification information.

The content conversion device 715 includes a data parsing device 7151, which is used to parse the data from said content; and a content generation device 7153, which is used to generate the content with the content format comprehended by the second entity on the basis of the parsed data and the correspondence between the content format comprehended by the second entity and the content format carried by the network service request.

The response conversion device 720 includes a data parsing device 721, which is used to parse the data from said network service response; and a response generation device 723, which is used to generate the network service response with the response format comprehended by the first entity on the basis of the parsed data and the correspondence between the response format comprehended by the first entity and the response format received by it.

It is noted that although the content conversion device 715 and the response conversion device 720 in FIG. 7 are shown as separate components, they can be a single component, that is, the data parsing device 7151 and the data parsing device 721 can be the same component, and the content generation device 7153 and the response generation device can be the same component.

Similarly, all components in the adapter 700 can be combined randomly, as long as the various functions of the adapter 700 can be completed. With respect to the detailed operation of the adapter 700 and its components, please refer to the detailed description of the method of the present invention in combination with FIGS. 2-6.

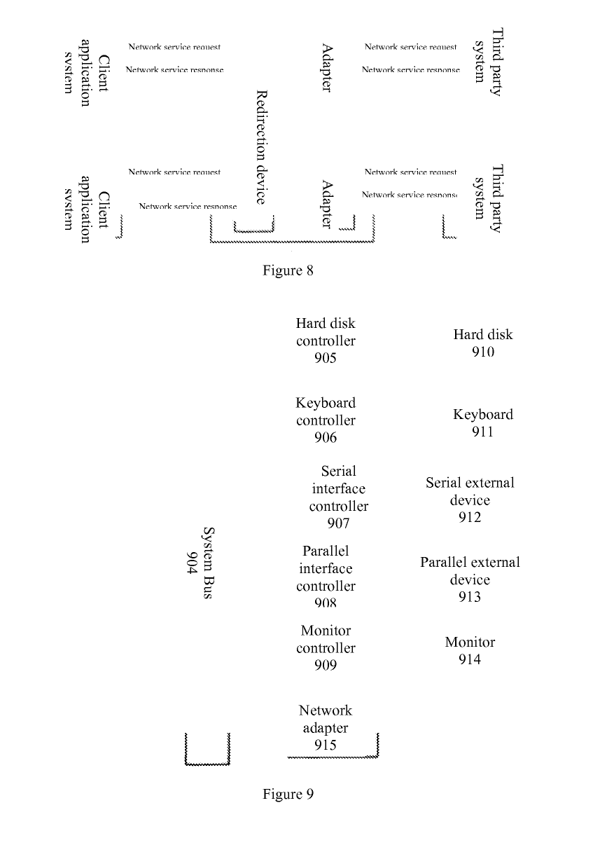

Moreover, the present invention also provides an adapter system. References to FIG. 8 are made to describe the adapter system 800 according to the embodiments of the present invention.

In FIG. 8, the adapter system 800 includes the adapters 811a-811n according to the embodiments of the present invention; a redirection device 810, which allocates the network service requests to the corresponding one or more adapters of the adapters 811a-811n based on the network service requested by the network service requests from the client application systems 801a-801n.

Next, the returned network service responses responded by the third party systems 803a-803n for these network service requests can also be transformed through the corresponding adapters, and then, via the redirection device 810 or not via the redirection device 810, such network service responses are returned to the client application systems which have sent such network service requests.

The adapter system according to the present invention provides a unified interface for different client application systems to access various different third party systems, so that different client application systems can enjoy the network service provided by various different third party systems through sending the network service requests of unified format to the unified address, without the need to take into consideration the specific operations of each adapter and various third party systems.

References to FIG. 9 are made to describe the computing devices, which can be used to realize the invention. FIG. 9 schematically shows the block diagram of the computing devices, which can be used to realize the embodiments of the present invention.

The computer system shown in FIG. 9 includes the central processing unit (CPU) 901, random access memory (RAM) 902, read-only memory (ROM) 903, system bus 904, hard disk controller 905, keyboard controller 906, serial interface controller 907, parallel interface controller 908, monitor controller 909, hard disk 910, keyboard 911, serial external device 912, parallel external device 913, monitor 914 and network adapter 915. Among these components, CPU 901, RAM 902, ROM 903, hard disk controller 905, keyboard controller 906, serial interface controller 907, parallel interface controller 908, monitor controller 909 and network adapter 915 are connected with the system bus 904. The hard disk 910 is connected with the hard disk controller 905, the keyboard 911 is connected with the keyboard controller 906, the serial external device 912 is connected with the serial interface controller 907, the parallel external device 913 is connected with the parallel interface controller 908, the monitor 914 is connected with the monitor controller 909, and the network adapter 915 allows the computer system to access the computer networks, such as the Internet.

The block diagram shown in FIG. 9 is intended to illustrate and not to limit this invention. In some circumstances, some devices may be added or reduced according to actual needs, for example, the computer used to achieve the invention can have no input/out devices, such as monitor and keyboard.

In addition, the embodiments of the present invention can be achieved by software, hardware or the combination of software and hardware. The hardware can be achieved by making use of the special logic; the software can be stored in the memory and its systems can be executed by appropriate instructions, for example, executed by microprocessor or dedicated design hardware.

This specification includes many details, which shall not be considered as limitations to the disclosed content or the scope of the claims, but the description of the realized features of the disclosure. In this specification, certain features separately realized and described in the context can be combined and individually achieved. On the contrary, the various features individually realized and described in the context can be realized by way of separately multiple realizations or any suitable sub-combination. Moreover, as mentioned above, although the features can be described to require protection when certain combinations are carried out or even initially, one or more features from the required combinations can be deleted from the combinations under certain circumstances, and the required combinations can be directed to the sub-combinations or the variants of sub-combinations.

Similarly, although the operations are described in a specific order in the attached drawings, it should not be understood that such operations are required to be performed according to the specific order as shown or in a sequential manner for the purpose of achieving the desired result, or all operations as shown are required to be performed. Under certain circumstances, multitasking and parallel processing are advantageous. In addition, with respect to the separation of the various system components of said realizations, it should not be understand that this separation is required in all realizations, and it should be further understood that the described program components and systems can be generally integrated in a single software product or packaged to become multiple software products.

Reference to the foregoing embodiments has been made to describe the invention, but it shall be understood that the invention is not limited by the disclosed embodiments. On the contrary, the invention aims to cover various changes and equivalent arrangements without departing from the spirit and scope of the appended claims. The scope of the claims below embodies the most extensive interpretation, so as to include all such changes and equivalent structures and functions.

What is claimed is:

1. A method for adaptation for the network service communication between a first entity and a second entity, comprising:
transforming a first network service request received from a first entity into a second network service request comprehended by a second entity, wherein said transformation of the first network service request includes:
identifying operations involved in the first network service request; and
depending on correspondences between operations used by the second entity and the identified operations, mapping the identified operations into the operations used by the second entity;
sending the transformed second network service request to the second entity;
receiving a first returned network service response responded by the second entity for the first network service request;
transforming the received first network service response into a second network service response comprehended by the first entity; and
returning the transformed second network service response to the first entity;
wherein the transformation of the received first network service response includes:
parsing data in the received first network service response; and
generating the second network service response with response format comprehended by the first entity based on the parsed data and correspondences between the response format comprehended by the first entity and response format received by the first entity;
wherein parsing data in the received first network service response includes parsing the data based on information carried by the received first network service response and linking relations between the data.

2. The method of claim 1, further comprising:
depending on correspondences between content format comprehended by the second entity and content format carried by the first network service request, transforming the content format carried by the network service request into the content format comprehended by the second entity.

3. The method of claim 1, further comprising:
extracting login information from the first network service request, so as to certify the first network service request according to certification information.

4. The method of claim 2, wherein said content transformation includes:
parsing data in the first network service request; and
generating content with content format comprehended by the second entity based on the parsed data and correspondences between the content format comprehended by the second entity and the content format carried by the first network service request.

5. The method of claim 4, wherein parsing data in the first network service request includes:
parsing the data based on information carried in the content in the first network service request and linking relations between the data.

6. The method of claim 1, wherein the linking relations between the data in the received first network service response are based on a single-level XML structure of plane structure format.

7. The method of claim 5, wherein the linking relations between the data in the first network service request are based on a single-level XML structure of plane structure format.

8. The method of claim 1, further comprising at least one of the following:
configuring correspondences between the operations used by the second entity and operations used by the first entity;
configuring certification information;
configuring correspondences between the response format comprehended by the first entity and the response format comprehended by the second entity; and
configuring correspondences between content format comprehended by the second entity and the response format comprehended by the first entity.

9. The method of claim 1, wherein the first entity is a client application system or a data application object, and the second entity is a third party system.

10. The method of claim 1, wherein the first entity is a third party system, and the second entity is a client application system or a data application object.

11. An adapter for the network service communication between a first entity and a second entity, comprising:
a request conversion device for transforming a first network service request received from a first entity into a second network service request comprehended by a second entity, wherein said transformation of the first network service request includes:
identifying operations involved in the first network service request; and
depending on correspondences between operations used by the second entity and the identified operations, mapping the identified operations into the operations used by the second entity;
a transceiver for sending the transformed second network service request to the second entity, and for receiving a first returned network service response responded by the second entity for the first network service request;
a response conversion device for transforming the received first network service response into a second network service response comprehended by the first entity;
said transceiver is also used for returning the transformed second network service response to the first entity;
wherein the response conversion device includes:
a first data parsing device for parsing data in the received first network service response; and
a response generation device for generating the second network service response with response format comprehended by the first entity based on the parsed data and correspondences between the response format comprehended by the first entity and response format received by the first entity;
wherein parsing data in the received first network service response includes parsing the data based on information carried by the received first network service response and linking relations between the data.

12. The adapter of claim 11, wherein said request conversion device also includes a content conversion device, which is used for:
depending on correspondences between content format comprehended by the second entity and content format carried by the first network service request, transforming the content format carried by the network service request into the content format comprehended by the second entity.

13. The adapter of claim 10, wherein said request conversion device also includes a certification device, which is used for:
extracting login information from the first network service request, so as to certify the first network service request according to certification information.

14. The adapter of claim 12, wherein the content conversion device includes a second data parsing device for parsing data in the first network service request, and for generating content with content format comprehended by the second entity based on the parsed data and correspondences between the content format comprehended by the second entity and the content format carried by the first network service request.

15. The adapter of claim 14, wherein said second data parsing device is also used for parsing the data based on information carried in the content in the first network service request and linking relations between the data.

16. The adapter of claim 11, wherein the linking relations between the data in the received first network service response are based on a single-level XML structure of plane structure format.

17. The adapter of claim 15, wherein the linking relations between the data in the received first network service response are based on a single-level XML structure of plane structure format.

18. The adapter of claim 11, further comprising a configurator, which is used for at least one of the following:
configuring correspondences between the operations used by the second entity and operations used by the first entity;
configuring certification information;
configuring correspondences between the response format comprehended by the first entity and the response format comprehended by the second entity; and
configuring correspondences between content format comprehended by the second entity and the response format comprehended by the first entity.

19. The adapter of claim 11, wherein the first entity is a client application system or a data application object, and the second entity is a third party system.

20. The adapter of claim 11, wherein the first entity is a third party system, and the second entity is a client application system or a data application object.
